(19) United States
(12) Patent Application Publication
(10) Pub. No.: US 2011/0224982 A1
(43) Pub. Date: Sep. 15, 2011

(54) AUTOMATIC SPEECH RECOGNITION BASED UPON INFORMATION RETRIEVAL METHODS

(75) Inventors: Alejandro Acero, Bellevue, WA (US); James Garnet Droppo, III, Carnation, WA (US); Xiaoqiang Xiao, State College, PA (US); Geoffrey G. Zweig, Sammamish, WA (US)

(73) Assignee: c/o Microsoft Corporation, Redmond, WA (US)

(21) Appl. No.: 12/722,556

(22) Filed: Mar. 12, 2010

(51) Int. Cl. G10L 15/02

(52) U.S. Cl. 704/236; 704/E15.004

(57) ABSTRACT

Described is a technology in which information retrieval (IR) techniques are used in a speech recognition (ASR) system. Acoustic units (e.g., phones, syllables, multi-phone units, words and/or phrases) are decoded, and features found from those acoustic units. The features are then used with IR techniques (e.g., TF-IDF based retrieval) to obtain a target output (a word or words). Also described is the use of IR techniques to provide a full large vocabulary continuous speech (LVCSR) recognizer

### BACKGROUND

Automatic speech recognition (ASR) is used in a number of scenarios. Voice-to-text is one such scenario, while another is telephony applications. In a telephony application, a call is routed or otherwise handled based upon the caller's spoken input, such as to map the spoken input to a business listing, or to map the audio to a command (transfer the caller to sales).

Hidden Markov models (HMMs) have been used in automatic speech recognition for several decades. Although HMMs are powerful modeling tools, HMMs have sequencing constraints associated with difficulties in modeling. HMMs are also not robust with respect to accented speech or background noise that differs from the speech/environment on which they were trained.

Any technology that improves speech recognition with respect to accuracy, including with accented speech and/or background noise, is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which automatic speech recognition uses information-retrieval based methods to convert speech into a recognition result such as a business listing, command, or decoded utterance. In one aspect, a recognition mechanism processes audio input into acoustic units. A feature extraction mechanism processes the acoustic units into corresponding features that represent the sequence of acoustic units. Based upon these features, an information retrieval-based scoring mechanism determines one or more words or acoustic scores associated with words based upon the features.

In various implementations, the recognition mechanism may output sub-word units, comprising phonemes, multi-phones or syllables, as the acoustic units, or may output words as the acoustic units. Features may include one or more n-gram unit features. Features may also include length-related information.

In one aspect, the acoustic scores may be used a continuous speech recognizer that combines the acoustic scores for words with a language model score to decode an utterance. Length information may be used as part of the decoding. Further, when there is an exact match between acoustic units and units in a dictionary used by the continuous speech recognizer, the continuous speech recognizer may change the acoustic score (e.g., maximize the score so that the dictionary word is correctly recognized).

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components in automatic speech recognition based upon information retrieval techniques.

FIG. 2 is a flow diagram showing example steps that may be taken to provide a large vocabulary continuous speech recognizer.

FIG. 3 shows an illustrative example of a computing environment into which various aspects of the present invention may be incorporated.

### DETAILED DESCRIPTION

Various aspects of the technology described herein are generally directed towards using information retrieval (IR) techniques with a speech recognition (ASR) system, which generally improves speed, accuracy, and scalability. To this end, in one implementation the IR-based system first decodes acoustic units (e.g., phones, syllables, multi-phone units, words and/or phrases), which are then mapped to a target output (a word or words) by the IR techniques. Also described is the use of IR techniques to provide a full large vocabulary continuous speech (LVCSR) recognizer

It should be understood that any of the examples described herein are non-limiting examples. For example, the technology described herein provides benefits with virtually any language, and may be used in many applications, including speech-to-text and telephony applications. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and speech recognition in general.

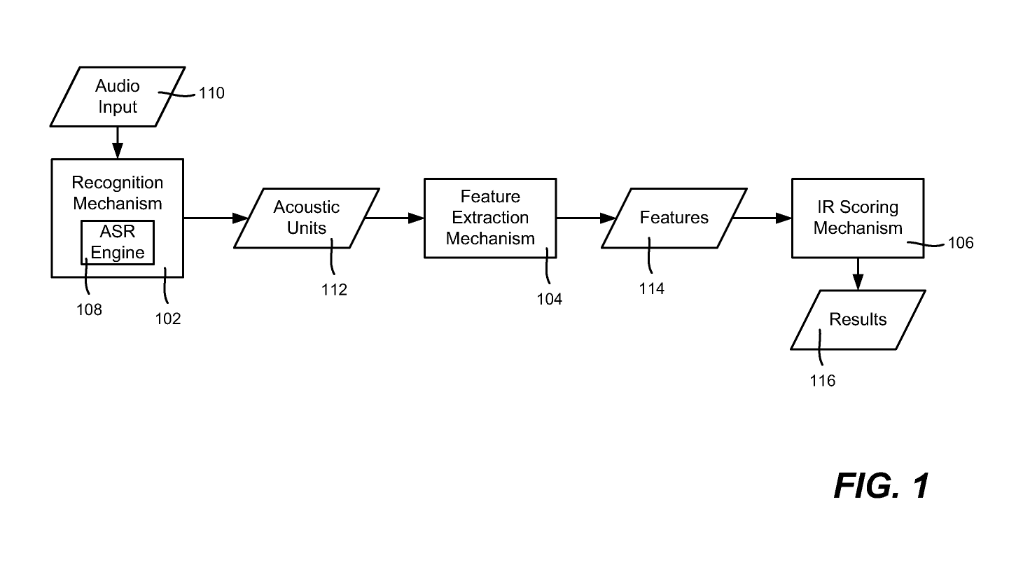

In one implementation generally represented in FIG. 1, an overall speech recognition procedure is performed by three main mechanisms, namely a recognition mechanism 102, a feature extraction mechanism 104, and an IR scoring mechanism 106 of an IR system.

As generally shown in FIG. 1, the recognition mechanism 102 uses an automatic speech recognition (ASR) engine 108 to provide a mapping from audio input 110 to a string of acoustic units 112. In general, the recognition mechanism 102 first decodes sub-word units as the acoustic units 112 (unlike conventional HMM-based speech recognition systems that decode words directly). Note that different pronunciation lexicons and language models may be used in the ASR engine 108 to produce recognition results with different levels of the acoustic units 112.

The recognition mechanism 102 thus maps the audio 110 into a sequence of acoustic units 112. As described herein, the same acoustic model may be used regardless of the acoustic unit chosen. By pairing it with different pronunciation lexicons and language models, recognition results are obtained at different levels of basic acoustic units, including phonetic recognition, multi-phone recognition, and word recognition. Note that it is feasible to have parallel recognizers output different levels of acoustic units; features may be extracted from each of the levels, and used in training/online recognition.

In general, as the size of the acoustic units is increased from phones to multi-phones to words, the effective phonetic error rate tends to decrease; however doing so leads to larger and more complex models. Also, the errors that remain with larger acoustic units are difficult to correct; e.g., if “PHARMACIES” is misrecognized as “MACY'S,” no known subsequent processing can correct the error. Thus, while decreasing the size of the acoustic units tends to increase the effective phonetic error rate, the system nevertheless has a chance to recover from some errors as long as enough of the phones are correctly recognized.

The acoustic units 112 are then mapped, via features, to a target word by the decoupled IR system, which in general serves as a lightweight, data-driven acoustic model. More particularly, the feature extraction mechanism 104 uses the acoustic units 112 to produce features 114 that may be used (with training data) to initially train the IR scoring mechanism 106, as well as be later used by a trained IR scoring mechanism 106 in online recognition. The features 114 may be defined over the acoustic units themselves, and/or in the case of sub-word or word units, the acoustic units may be divided into phonetic constituents before feature extraction. Additional examples of feature extraction are described below.

FIG. 1 shows the IR scoring mechanism providing results 116. As can be readily appreciated, these may be online recognition results (e.g., words such as business listings or commands) for recognized user speech once the system is trained. The results 116 alternatively may comprise candidate scores and the like, such as for combining with a language model score in a continuous speech recognition application to recognize an utterance, as described below. Still further, the results 116 may be part of the training process, e.g., the results may be any suitable data used in discriminative training or the like to converge vector term weights until they suitably recognize labeled training data.

In one implementation, the IR scoring mechanism 106 comprises vector space model-based (VSM-based) scoring. In the vector space model, a cosine similarity measure is used to score the likelihood between a query (e.g., the acoustic units may be considered analogous to query “terms”) and each training document (e.g., the business listings or commands or individual words may be considered analogous to “documents”). In this way, an IR system is used to map directly from acoustic units to desired listings, for example. As will be understood, the technology needs only one pass to directly map a sequence of recognized sub-word units to a final hypothesis.

Training is based on creating an acoustic units-to-business listing, (analogous to a term-document) matrix over the appropriate features, in a telephony example where business listings are provided. Note that other application-specific data such as a telephony-related command set (e.g., transfer call to technical support if the caller responds with speech that provides the appropriate acoustic units) may correspond to documents. The weights in the matrix may be initialized with the well-known IR formulae such as term frequency-inverse document frequency (TF-IDF) or BM25, or discriminatively trained using a minimum classification error criterion or other training techniques such as maximum entropy model training.

In an alternative implementation, the IR scoring mechanism 106 comprises language model-based scoring. In this implementation, one language model is built for each “document” collection. In the language model, any phone n-gram probability may be estimated for the associated document based on the labeled training data. The probability of a certain document given a pronunciation of testing query can then be estimated. Language model-based scoring is based on those estimated probabilities for each document.

A general advantage of using IR in mapping from acoustic units to listings is that it provides a more flexible pronunciation model. In contemporary automatic speech recognition systems, if the speaker has an accent, talks casually, and/or if there is sufficient background noise, there is a mismatch between the expected pronunciation from the dictionary and the realized pronunciation of the utterance. Given enough training data, the IR system can replace a small number of canonical pronunciations with a learned, discriminative distribution over sub-word units for each listing. Another advantage of using IR in automatic speech recognition is that the vector space model used in IR has no sequencing constraints, which tends to lead to a system that is more robust to disfluencies and noise. Because of the discriminative nature of an IR engine, a word may be recognized by emphasizing a well-pronounced discriminative core while de-emphasizing any noisy extremities. In the example of PHARMACY (shown in the following table representing a document combining canonical and training pronunciations), the first syllable may be more stable than the other two:

| | |
|---|---|
| PHARMACY (canonical pronunciation) | F AA R M AX S IY |
| PHARMACY (training pronunciation 1) | F AO R M AX S IY |
| PHARMACY (training pronunciation 2) | F AY R IH S IY |
| PHARMACY (training pronunciation 3) | F AY R N AX S IY |

As set forth above, in various implementations, the acoustic units 112 comprise a sequence of phones, multi-phones, or words. Features can be extracted from this sequence, and/or the acoustic units may be mapped into an equivalent phonetic string from which features are extracted. Note that the set of possible n-gram features on the recognition output is virtually unlimited; a large training set thus contains millions of such features; various rules may be used to select an appropriate subset of these n-gram features from the training data.

By way of example, the following table enumerates some of the twenty-eight possible n-gram units extracted from a single utterance, that is, some of the possible n-grams extracted from an instance of PHARMACY when fed through a phonetic recognition system:

| | |
|---|---|
| unigrams | F, AO, R, M, AX, S, IY |
| bigrams | F-AO, AO-R, R-M, M-AX, AX-S, S-IY |
| trigrams | F-AO-R, AO-R-M, R-M-AX, M-AX-S, AX-S-IY |
| . . . | . . . |
| 7-grams | F-AO-R-M-AX-S-IY |

With respect to bigram unit features, the complete set of bigrams is not large, e.g., in one large set of training data, approximately of 1,200 bigrams exist Further, bigrams contain more sequencing information than unigram features, which helps to reduce the effective homophones introduced when feature order is ignored. Moreover, when compared to longer units, bigrams tend to be more robust to recognition errors. For example, an error that perturbs a single phone changes two bigram units in an utterance, but the same error changes three trigram units.

For units where a sufficient amount of training data is available, the mutual information between the existence of that unit in a training example and the word labels may be computed. In the following, I(u)={0,1} indicates the presence or absence of a sub-word unit u. The mutual information between a unit u and the words W in the training data is given by:

$$MI ( u , W ) = {\sum }_{I ( u )} {\sum }_{w ∈ W} P ( I ( u ) , w ) log [ \frac{P ( I ( u ) , w )}{P ( I ( u ) ) P ( w )} ] . \qquad ( 1 )$$

P(I(u),w), P(I(u)) and P(w) can be estimated from a counting procedure in the training data. The sub-word units in the training data then may be ranked based on the mutual information measure, with only the highest-ranked units selected.

Turning to additional details of training, in training the general goal of IR scoring is to efficiently find the training document that most closely matches the testing query. The two scoring schemes, vector space model based IR and language model based IR, are described below with respect to training.

In the vector space model (VSM), each dimension corresponds to one of the acoustic unit features. To remain consistent with IR terminology, each feature is thus analogous to and may be substituted with “term” herein; each listing is likewise analogous to and may be substituted by “document” herein.

Vector space model training constructs a document vector for each document (listing) in the training data. This vector comprises weights learned or calculated from the training data. As used herein, each training document may represent a pool of examples that share the same listing. Each test example is interpreted as a query, composed of terms, which is also used to construct a query vector.

The similarity between a testing query q (with query vector v_{q} with elements v_{qk}) and a training document d (with document vector v_{d} with elements v_{dk}) is given by their cosine similarity, a normalized inner product of the corresponding vectors.

$$cos ( {v}_{q} , {v}_{d} ) = \frac{{\sum }_{k} {v}_{qk} {v}_{dk}}{\vert {v}_{q} \vert \vert {v}_{d} \vert} \qquad ( 2 )$$

A straightforward method of computing the document vectors directly from the training examples is to use the well-known TF-IDF formula from the information retrieval field. This weighting may be computed directly from counting examples in the training data as follows:

$${v}_{jk} = \frac{{f}_{jk}}{{m}_{j}} \cdot ( 1 + {log}_{2} ( \frac{n}{{n}_{k}} ) ) , j = q , d . \qquad ( 3 )$$

In equation (3),

$$\frac{{f}_{jk}}{{m}_{j}}$$

is the term frequency (TF), where fⱼₖ is the number of times term k appears in query or document j and mⱼ is the maximum frequency of any term in the same query or document.

$$1 + {log}_{2} ( \frac{n}{{n}_{k}} )$$

is the inverse document frequency (IDF), where nₖ is the number of training queries that contain term k and n is the total number of training queries.

An N×K term-document matrix is then created with the TFIDF weighted training document vectors as its parameters. The rows represent the N terms and the columns the K training documents. The transpose of the term-document matrix is the routing matrix R with its row rᵢ as the document vector. A query q is routed to the document i with the highest cosine similarity score:

$$document \hat{ i} = arg {max}_{i} cos ( {v}_{q} , {r}_{i} ) . \qquad ( 4 )$$

Another method of computing the document vectors is discriminative training. More particularly, the routing matrix may be discriminatively trained based on minimum classification error criterion using known procedures. The discriminant function for document j and observed query vector x is defined as the dot product of the model vector and query vector:

g(x, R)=rⱼ·x=Σₖrₖxₖ. (5)

Given that the correct target document for x is c, the misclassification function is defined as:

$${d}_{c} ( x , R ) = - {g}_{c} ( x , R ) + {[ \frac{1}{K - 1} {\sum }_{i \neq c , 1 \leq i \leq k} {{g}_{i} ( x , R )}^{η} ]}^{η} . \qquad ( 6 )$$

Then the class loss function with L₂ regularization is:

$${l}_{c} ( x , R ) = \frac{1}{1 + {exp}^{- γ {d}_{c} + θ}} + λ {\sum }_{i} \vert \vert {r}_{i} {\vert \vert}^{2} . \qquad ( 7 )$$

As is known, L₂ regularization is used to prevent over-fitting the training data; λ is set to be 100 in one implementation. The other parameters in equation (6) and equation (7) may be set in any suitable way, such as based upon those set forth by H-K. J. Kuo and C.-H. Lee in “Discriminative training in natural language call routing,” in Proc. of ICSLP, (2000). A batch gradient descent algorithm with the known RPROP algorithm may be used to search for the optimum weights in the routing matrix.

In the other described alternative, language model-based scoring, a language model defines a probability distribution over sequences of symbols. In one implementation, language model-based IR trains a language model for each document, and then the scoring is based on the probability of a training document d given a testing query q. The target correct document \hat{d} for the query q can then be obtained via:

$$document \hat{ d} = arg {max}_{d} P ( d \vert q ) = arg {max}_{d} P ( q \vert d ) P ( d ) . \qquad ( 8 )$$

In equation (8), P(d) can be estimated by dividing the number of training queries in document d by the number of all training queries. Assuming the pronunciation of query q is p₁, p₂, . . . , pₘ, P(q|d) can then be modeled by a n-gram language model:

P(q|d)=ΠᵢP(pᵢ|pᵢ₋ₙ₊₁, . . . , pᵢ₋₁; d), (9)

where ΠᵢP(pᵢ|p_{i″n+1}, . . . pᵢ₋₁; d) can be estimated by a counting procedure. It is possible that a many n-grams are rarely seen or unseen in the training data, in which cases the counting does not give a reasonable estimate of the probability; smoothing techniques may thus be used. In one implementation, a known (Witten-Bell) smoothing scheme was used to calculate the discounted probability, which is able to smooth the probability of seen n-grams and assign some probability for the unseen n-grams.

Turning to another aspect, the above-described IR techniques may be extended to implement a full large vocabulary continuous speech (LVCSR) recognizer. In general, instead of using HMMs and/or Gaussian Mixture Models (GMMS) to come up with acoustic scores for possible words in an utterance, the above-described IR techniques may be used to determine the acoustic scores. More particularly, an utterance may be converted to phonemes or sub-word units, which are then divided into various possible segments. The segments are then measured against word labels based upon TF-IDF, for example, to find acoustic scores for possible words of the utterance. The acoustic scores are used in various hypotheses along with a length score and a language model score to rank candidate phrases for the utterance.

As described herein, a dictionary file may be used, which contains for each word the various ways in which it has been decoded as a sequence of units. The file may also include the ways in which the word is represented in an existing, linguistically derived dictionary.

By way of example, in the dictionary file some lines for the word “bird” may include (shown as a table):

| | | | |
|---|---|---|---|
| bird | b er r d | 19 | b er r |
| bird | b er r d | 15 | b er r d |
| bird | b er r d | 9 | b er r t |
| bird | b er r d | 7 | b er r g |
| bird | b er r d | 4 | v ax r d |
| bird | b er r d | 4 | b er r g ih |
| bird | b er r d | 3 | b er r g ih t |

The above example indicates that “bird” (with expected dictionary pronunciation “b er r d”), occurs nineteen times without the last “d”, fifteen times as expected, nine times as “b er r t”, and so on, including three times as “b er r g ih t”. This last unusual pronunciation is likely present due to speech recognition errors.

Decoding then operates on a sequence of detected units, for example, dh ah b er r t f l ay z (the bird flies).

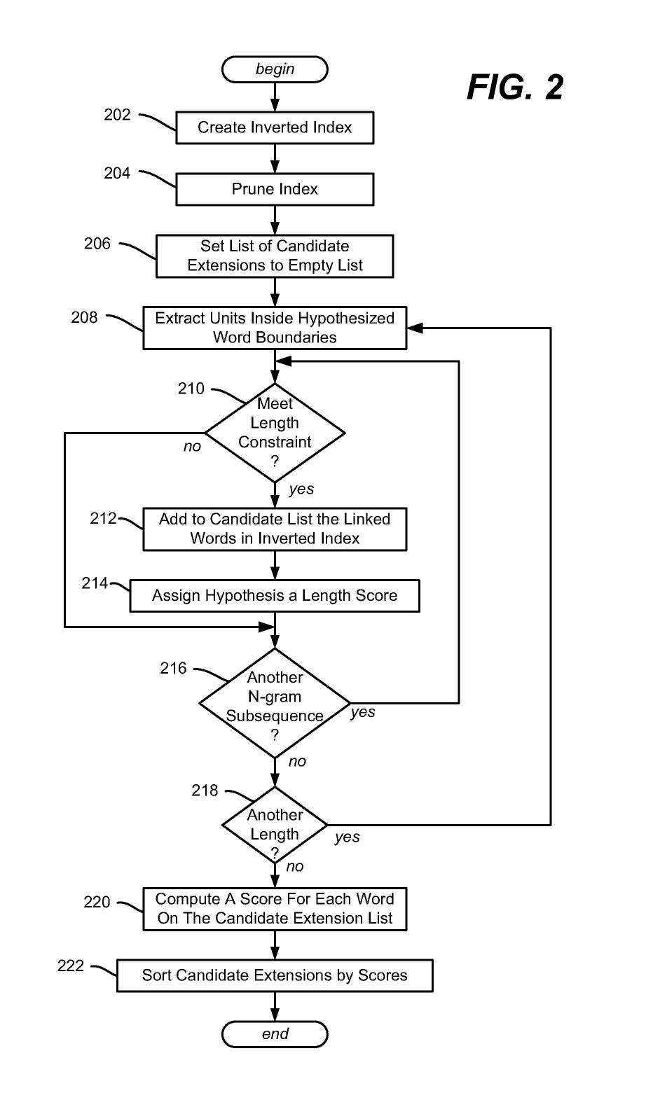

To implement the large vocabulary continuous speech recognizer decoder, the process generally represented in FIG. 2 may be used. Step 202 represents creating an inverted index that indicates, for each n-gram of units, which words in the dictionary contain that n-gram of units. In an implementation in which phonetic units are used, 2-grams provide desirable results. In an implementation in which multi-phone units are used, 1-grams provide desirable results.

For practical applications, and to screen out non-typical sequences, this index may be pruned, as represented by step 204. In one implementation, if a unit sequence is not present in at least x (e.g., ten) percent of a word's pronunciations, the unit sequence is not placed in the index. For example, with a ten percent threshold and 2-grams, the pair “r t” (from the third file entry in the above table) is linked as possible evidence for the presence of “bird”. However, “ih t” (from the last file entry) is not.

The process continues at step 206 by performing a search for the best word sequence, using a stack based decoder, for example. Such a decoder combines a full n-gram language model score with the TF-IDF-based acoustic score when the decoder extends a candidate path with a word.

To find possible the possible extensions for a partial path that ends at position “i”, the possible end-positions up to position i+k are considered. For a phoneme system, a typical value of k is fifteen, while for a multi-phone system, a suitable typical value of k is ten.

More particularly, to search algorithmically, step 206 sets the list of candidate extensions to an empty list. For each length 1 . . . , k, (as repeated via step 218), the ending phone is assumed to be position i+k−1.

Given hypothesized word boundaries, the process extracts the units inside the boundaries at step 208. In the example above, when i is 3 and j is 4, the sequence “b er r t” is provided. Subject to a length constraint (step 210, described below), for each n-gram subsequence of units (as repeated by step 216), at step 212 the process adds to a candidate list the words that are in the inverted index (that was built at step 202) which are linked to the subsequence. Further, at step 214 the hypothesis is assigned a length score, e.g., equal to the square of the difference between the expected and hypothesized lengths. In one implementation, the length constraint at step 210 evaluates whether the length of the average pronunciation of the word (as judged by the dictionary) differs by more than t phones from k; if so, it is not met and not considered further. A suitable value for t is 4.

Step 220 computes a score for each word on the candidate extension list, such as score=a(log(TF-IDF score))+b(length score)+c(unigram language model score). Suitable values for a, b and c are a=1, b=0.1 and c=0.02. Step 222 sorts the candidate extensions by this score.

The partial path may be extended by each of the top-k candidates, where a suitable value for k is 50. The word score used in this extension may be as before, with the unigram LM score replaced with a full n-gram LM score.

It should be noted that in an efficient implementation, all possible word labels for all possible unit subsequences of the input may be computed just once before the stack search is initiated. This may be done by performing steps 206-222 once for each position in the input stream.

In a further alternative to the computation of the acoustic score, a score of zero (0) may be used in a situation in which there is an exact match (XM) between the units in a block and the units in the existing dictionary pronunciation of a word. In other words, the acoustic score (AC) is:

$$min \{ \begin{matrix}T F I D F + length \\ XM ( 0 )\end{matrix}$$

It can be readily appreciated the above description may be modified while still adopting the general principles and methodology that is outlined. For example, if performing lattice rescoring rather than full decoding, an out-of-vocabulary word in the lattice, or a word with a previously unseen acoustic unit may have an ill-defined TF-IDF score. In this case, an acoustic score may be used that is proportional to the length of the hypothesized block of units, or to the length of the hypothesized word, or both.

### Exemplary Operating Environment

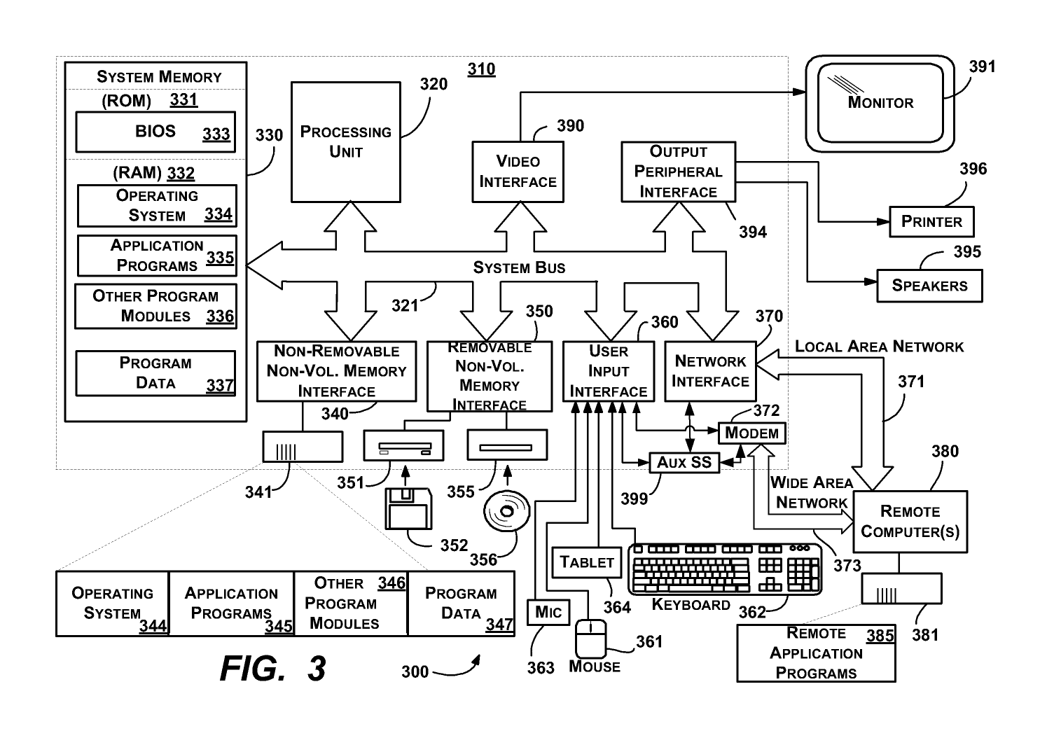

FIG. 3 illustrates an example of a suitable computing and networking environment 300 on which the examples of FIGS. 1 and 2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising:
a recognition mechanism that processes audio input into acoustic units;
a feature extraction mechanism that processes the acoustic units into features derived from the acoustic units; and
an information retrieval-based scoring mechanism that inputs the features and determines one or more words or acoustic scores associated with words based upon the features.

2. The system of claim 1 wherein the recognition mechanism outputs information corresponding to sub-word units, comprising phonemes, multi-phones or syllables, as the acoustic units.

3. The system of claim 1 wherein the recognition mechanism outputs information corresponding to words as the acoustic units.

4. The system of claim 1 wherein the features comprise one or more n-gram unit features.

5. The system of claim 1 wherein features comprise length-related information.

6. The system of claim 1 wherein the one or more words or acoustic scores are used by a telephony application.

7. The system of claim 1 wherein the one or more words or acoustic scores are used by a continuous speech recognizer, including by combining information retrieval-based acoustic scores associated with each word with a language model score to decode an utterance.

8. The system of claim 7 wherein the acoustic score is variable depending on whether there is an exact match between acoustic units and units in a dictionary used by the continuous speech recognizer.

9. The system of claim 1 wherein the one or more words or acoustic scores are used by a continuous speech recognizer, including by combining information retrieval-based acoustic scores associated with each word with length data and a language model score to decode an utterance.

10. The system of claim 1 wherein the information retrieval-based scoring mechanism comprises a vector space model-based scoring mechanism.

11. The system of claim 10 wherein the vector space model-based scoring mechanism is trained based upon TF-IDF counts in training data to determine term weights.

12. The system of claim 10 wherein the vector space model-based scoring mechanism is trained based upon training data and discriminative training to determine term weights.

13. The system of claim 1 wherein the information retrieval-based scoring mechanism comprises a language model-based scoring mechanism.

14. In a computing environment, a method performed on at least one processor, comprising, processing audio input into acoustic units, extracting features corresponding to the acoustic units, and using information retrieval-based scoring to determine acoustic scores for words based upon the features.

15. The method of claim 14 further comprising, providing a business listing based upon the acoustic scores for the words.

16. The method of claim 14 further comprising, using the acoustic scores for a plurality of candidate words with length data and a language model score to decode an utterance.

17. The method of claim 16 further comprising, determining whether there is an exact match between acoustic units and units in a dictionary, and if so, changing the acoustic score.

18. One or more computer-readable media having computer-executable instructions, which when executed perform steps, comprising:
receiving speech;
extracting units based upon the speech and hypothesized word boundaries;
determining candidate words that are associated with the units;
computing an information-retrieval based acoustic score for each candidate word and associating that acoustic score with that candidate word; and
sorting the candidate words by acoustic score.

19. The one or more computer-readable media of claim 18 having further computer-executable instructions comprising, combining at least some of the candidate words into n-gram sequences, and determining an utterance based on the scores associated with candidate words of an n-gram sequence with a language model score.

20. The one or more computer-readable media of claim 18 having further computer-executable instructions comprising, determining whether there is an exact match between a set of acoustic units corresponding to a word and units in a dictionary, and if so, changing the acoustic score associated with that word.
